(19) United States
(12) Patent Application Publication
(10) Pub. No.: US 2010/0196651 A1
(43) Pub. Date: Aug. 5, 2010

(54) MOLD MANUFACTURING OF AN OBJECT COMPRISING A FUNCTIONAL ELEMENT, TRANSFERING PROCESS AND OBJECT

(75) Inventors: Chih-Yuan Liao, Hsinchu County (TW); Andrew Ho, Atherton, CA (US); Shun-Cheng Wang, Taoyuan County (TW); Shih-Min Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SIPIX CHEMICAL INC., Taoyuan County (TW)

(21) Appl. No.: 12/758,026

(22) Filed: Apr. 11, 2010

Related U.S. Application Data
(63) Continuation-in-part of application No. 11/513,333, filed on Aug. 29, 2006, now abandoned.
(60) Provisional application No. 60/721,861, filed on Sep. 28, 2005.

(51) Int. Cl. B32B 27/36; B32B 37/12; B29C 45/14; B32B 7/12; B32B 3/02; B32B 27/42; B32B 27/40; B32B 27/32; B32B 27/38; B32B 27/30; B32B 27/28; B29C 45/02

(52) U.S. Cl. 428/76; 156/60; 156/230; 264/516; 264/241; 428/352; 428/412; 428/414; 428/423.1; 428/448; 428/473.5; 428/474.4; 428/480; 428/500; 428/523; 428/524

(57) ABSTRACT

This invention relates to an object having a functional element embedded in its top surface and processes for its manufacturing. The object is in general formed by molding, stamping, lamination or a combination thereof. The functional element is includes any electrical or mechanical elements that are capable of performing a function.

### CROSS-REFERENCE TO RELATED APPLICATION

This is a continuation-in-part application of and claims priority benefit of patent application Ser. No. 11/513,333, filed on Aug. 29, 2006, which claims the priority benefit of U.S. provisional application No. 60/721,861 filed on Sep. 28, 2005. The entirety of each of the above-mentioned patent applications is hereby incorporated by reference herein and made a part of this specification.

### BACKGROUND OF THE INVENTION

1. Field of the Invention

This invention relates to an object comprising a functional element embedded in its surface, processes for its manufacture, a transferring process and an object processed with the transferring process.

2. Description of Related Art

Currently, for an object having a functional element, the object and the functional element are manufactured separately and the two components are then assembled together. The assembly of such an object usually requires mechanical integration or lamination, and therefore it is carried out batch by batch. In other words, the object cannot be manufactured by a continuous process. In addition, the mechanical integration or lamination process typically results in a large gap between the object and the functional element and also an increase in the total thickness or volume of the object. As a result, the current methods are not only time-consuming but also labor intensive. In addition, in order to meet desired specifications, such as style, compactness, durability, and other features that are important for handheld devices, the current methods could be prohibitively costly.

A transferring process is used to transfer a pattern on a carrier layer to an object by pressurizing for making appearance of the object to be changeful. In order to protect the pattern transferred to the object, a protecting film is formed by spraying after the transferring process in conventional. However, the spraying not only brings environment contamination but also wastes a lot of spraying material and increases, cost. Since the conventional transferring process has said defects, an in-mold decoration (IMD) becomes another choice for forming the pattern on the object. While the conventional IMD is applied on the object having non-planar surface, the transferred pattern at a curved surface of the object may crack easily, the transfer film may be wrinkled up, and bubbles may exist between the transfer film and the object. Meanwhile, the IMD attaches the transfer film to the plastic object during an injection molding, a heat-pressing forming, a compressing forming, a blow molding or an extrusion molding. However, the functional element disposed in the transfer film may be damaged by the high temperature and high pressure during the IMD.

### SUMMARY OF THE INVENTION

The first aspect of the invention is directed to an object having at least one functional element embedded in its top surface. The object may also have a decorative design (e.g., text or graphic), a display panel or both, appearing on the object.

The second aspect of the invention is directed to an in-mold transfer film or foil.

The third aspect of the present invention is directed to an in-mold insertion film or foil.

The fourth aspect of the invention is directed to processes for the manufacturing of the object of the first aspect of the invention.

When a functional element is embedded in the surface of an object, the seamless integration produces a very appealing look. The functional element may conform to the shape of the object, even if the surface is curved. As a result, the functional element may appear as an integral part of the object.

The invention is directed to a transferring process including the following steps. An object is disposed on a stage. A transfer film is disposed on the object. The transfer film is heated and pressurized by using a tool, such that a part of the transfer film where heated and pressurized by the tool is attached to the object. The transfer film and the object are disposed in a chamber. Air in the chamber is extracted, such that other part of the transfer film where not heated and pressurized by the tool is attached to the object.

In one embodiment of the present invention, the transfer film includes a temporary carrier layer, a release layer, a functional element and an adhesive layer. The release layer is disposed on the temporary carrier layer. The functional element is disposed on the release layer. The adhesive layer is disposed on the release layer. While the transfer film is disposed on the object; the functional element and the adhesive layer are between the object and the temporary carrier layer. Moreover, the transfer film may further include a durable layer. The durable layer is disposed on the release layer, and the functional element and the adhesive layer are disposed on the durable layer. Furthermore, the transferring process may further include removing the temporary carrier layer and the release layer and keeping the durable layer, the functional element and the adhesive layer on the object after the other part of the transfer film where not heated and pressurized by the tool is attached to the object. The transfer film may further include an ink layer, the ink layer is disposed on the release layer and covers the functional element, and the adhesive layer is disposed on the ink layer.

In one embodiment of the present invention, the transferring process further include disposing a functional element on the object before disposing the transfer film on the object, wherein the functional element is between the transfer film and the object.

In one embodiment of the present invention, the functional element is an integral circuit.

In one embodiment of the present invention, the step of using the tool to heat and pressurize the transfer film is using a roller to heat and pressurize the transfer film.

In one embodiment of the present invention, the step of using the tool to heat and pressurize the transfer film is proceeded at 80° C. to 250° C.

In one embodiment of the present invention, a temperature of the chamber during extracting air from the chamber is 50° C. to 300° C.

In one embodiment of the present invention, the stage has a fixture for fixing the transfer film on the object after disposing the transfer film on the object.

In one embodiment of the present invention, the part of the transfer film where heated and pressurized by the tool is attached to a planar surface of the object, and the other part of the transfer film where not heated and pressurized by the tool is attached to a non-planar surface of the object. An included angle of a junction of the non-planar surface and the planar surface is 10° to 90°.

In one embodiment of the present invention, the stage has a vacuum pipeline, the step that extracting air from the chamber is proceeded via the vacuum pipeline.

The invention is directed to an object processed with said transferring process. Moreover, a material of a part of the object contacted with the transfer film is selected from polycarbonate, polypropylene, polyacrylate, styrene-methyl methacrylate copolymer, acrylonitrile butadiene styrene, polystyrene, polyethylene terephthalate, polyoxymethylene or combination thereof.

The objects produced by the present invention have a wide variety of applications. For example, the objects may be touch or push panels, color filters, backlight boards, speakers, microphones, clocks, watches, radio panels, mobile phones, cases of digital camera, cases of personal digital assistant, cases of notebook computer, cases of touch panel, cases of TV, cases of GPS, cases of car-display, cases of aero-display, cases of digital photo frame, cases of DVD player, dressing cases, toys, dashboards, cases of radio, credit cards, smart cards or cases of other electronic devices. This list is clearly not exhaustive. Other applications would be clear to a person skilled in the art in light of the description below and therefore they are all encompassed within the scope of the present invention.

### BRIEF DESCRIPTION OF THE DRAWINGS

FIG. 1 shows the top view of an object of the present invention.

FIG. 2a is a cross-section view of an in-mold transfer film or foil comprising a functional element.

FIG. 2b is a cross-section view of an in-mold insertion film or foil comprising a functional element.

FIG. 3a is the cross-section view of an injection molding process involving an in-mold transfer film or foil.

FIG. 3b is the cross-section view of an injection molding process involving an in-mold insertion film or foil.

FIGS. 4a and 4b illustrate an object of the present invention having an inner cavity.

FIG. 5 is a flow chart of a transferring process of an embodiment of the present invention.

FIGS. 6 to 9 illustrate parts of steps of the transferring process in FIG. 5.

FIG. 10 is a transfer film of another embodiment of the present invention.

FIG. 11 is a flow chart of a transferring process of another embodiment of the present invention.

FIG. 12 illustrates parts of steps of the transferring process in FIG. 10.

### DESCRIPTION OF THE EMBODIMENTS

The term “functional element” referred to throughout this application broadly includes any electrical or mechanical elements which are capable of performing a function. Examples of such functional elements may include, but are not limited to, optical components, optical devices, waveguides, electronic designs such as conductive or semi-conductive electrical traces, and electronic components such as integrated circuits, printed electrical circuits, transistors, diodes, resistors, inductors, capacitors, antennas, RFID transponders, batteries, solar cells, light-emitting diodes (LEDs), and other diodes not limited to LED, organic light-emitting diodes (OLEDs), display components, backlight components, speakers, microphones, push buttons, touch panels, touch pads, connectors and the like.

The term “embedded in the top surface”, in the context of the present invention, is intended to indicate that the functional element is integrated into the top surface of an object when the object is being formed, not after the object is formed; the functional element is not mounted within the object.

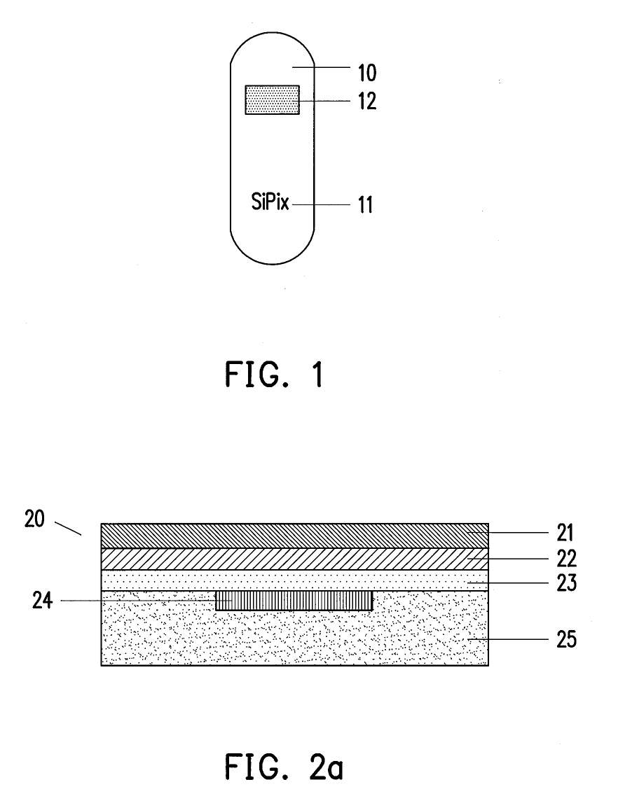

FIG. 1 shows an object (10) comprising a functional element (11) embedded in its surface. The object may be viewed from the functional element side as shown. Alternatively, the object may be viewed from the opposite side and in such a case; the functional element would not be visible to the viewer.

There may also be a decorative element (12), a display element (not shown) or both, appearing on the object.

There are a number of different methods which may be employed to embed a functional element in the surface of an object. Two examples are given below. Although the term “in-mold” is used, it is understood that the present invention can be extended to processes such as stamping, lamination, thermoforming, injection molding, compression molding, blow molding or a combination of stamping or lamination with a molding process.

### (I) In-Mold Transfer Films or Foils

In one approach, an in-mold transfer film or foil comprising a functional element is first prepared.

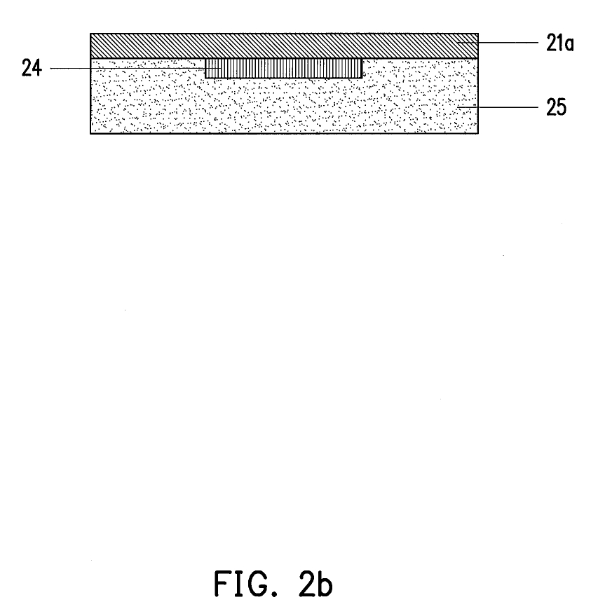

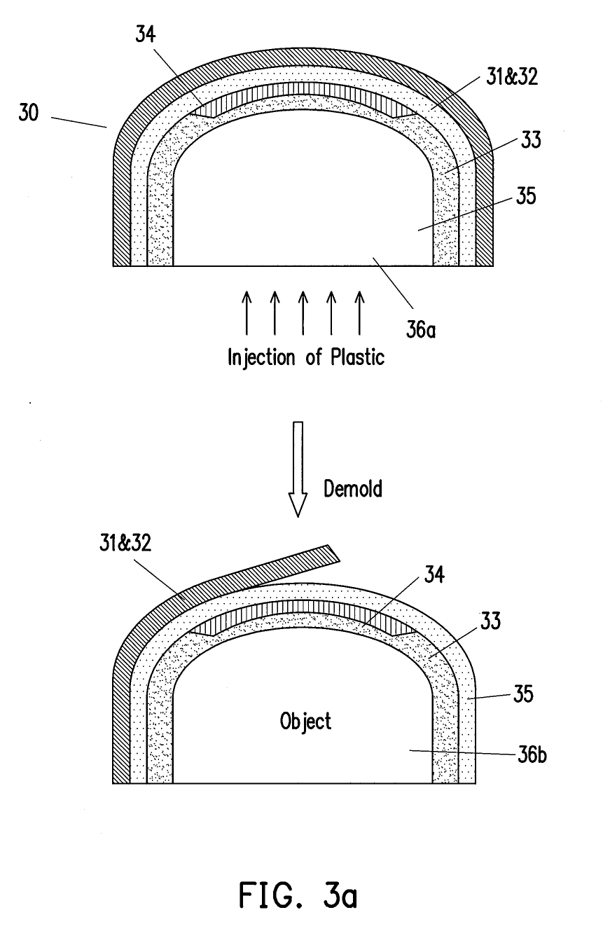

FIG. 2a is a cross-section view of such an in-mold transfer film or foil (20) which comprises a carrier layer (21), a release layer (22), an optional durable layer (23), a functional element (24) and an adhesive or tie-coat layer (25).

The release layer (22), the durable layer (23) if present, and the adhesive layer (25) are sequentially coated or laminated onto the carrier layer (21) and these different layers are collectively referred to as the “in-mold transfer film or foil” in this application for ease of illustration.

When no durable layer is present, the functional element (24) is present between the release layer (22) and the adhesive layer (25). This may be accomplished by applying the functional element to the release layer or to the adhesive layer before the layers are sequentially coated to form an in-mold transfer film or foil.

When a durable layer is present, the functional element may be applied to a durable layer coated film. The functional element may be present between the release layer and the durable layer or between the durable layer and the adhesive layer.

Alternatively, a composite film with a functional element sandwiched between two adhesive layers may be used to be laminated onto the release layer or a durable-release coated film. The two adhesive layers are required as one of the two adhesive layers is to ensure adhesion between the composite film and the release layer or the durable-release film and the other adhesive layer is to ensure adhesive between the composite film and the injection molding resin. The latter adhesive layer in fact is the adhesive layer (25) in FIG. 2a. The composite film as described in fact serves as a supporting layer in the in-mold transfer film or foil.

The application of the functional element to the release, durable-release film, adhesive or tie-coat layer may be accomplished by methods such as printing, coating, sputtering, vapor deposition, spraying, plating, pasting, etching, lamination or the like. It may also be accomplished by a combination of any of these methods. In one embodiment, the functional element may be formed first and then transferred onto the layer. In another embodiment, the functional element may be formed directly onto the layer. But in any case, the evenness and smoothness of the surface of the object should not be affected due to the presence of the functional element.

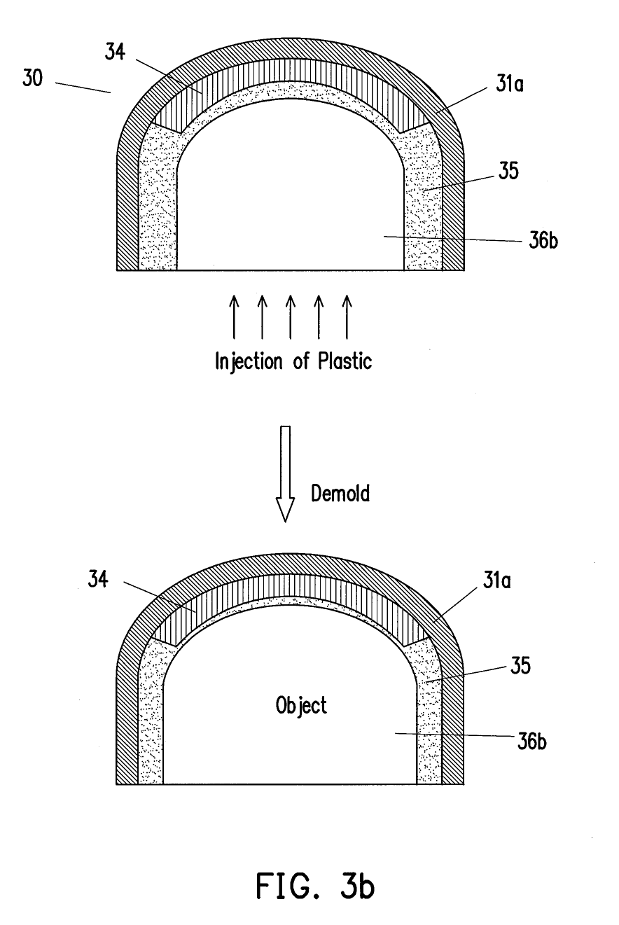

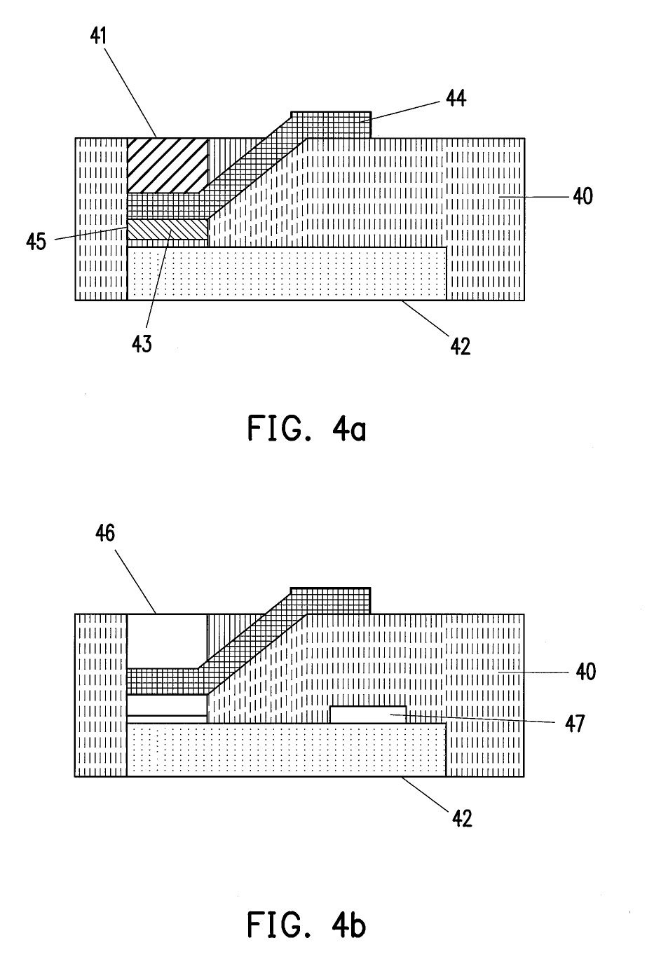

In the in-mold transfer process, the in-mold transfer film or foil is fed into a mold with the carrier layer (21) in contact with the mold surface, as shown in FIG. 3a.

The carrier layer (21) usually is a thin plastic film with a thickness from about 3.5 to about 200 microns. Polyethylene terephthalate (PET), polyethylene naphthalate (PEN) and polycarbonate (PC) films are preferred because of their low cost, high transparency and thermo mechanical stability.

The release layer (22) allows the functional element (24) to be released from the carrier layer in a manner that minimizes damage to the functional element and enables a fully automated roll transfer process during molding.

The release layer usually is a low surface tension coating prepared from a material such as wax, paraffin or silicone or a highly smooth and impermeable coating prepared from a material such as radiation curable multifunctional acrylates, silicone acrylates, epoxies, vinyl esters, vinyl ethers, alkyls and vinyl's, unsaturated polyesters or blends thereof. The release layer may comprise a condensation polymer, copolymer, blend or composite selected from the group consisting of epoxy, polyurethane, polyimide, polyamide, melamine formaldehyde, urea formaldehyde and phenol formaldehyde.

Another suitable release layer composition is disclosed in US 2005-0255314, the content of which is incorporated herein by reference in its entirety. Briefly, the release layer comprises a copolymer or interpenetration network (IPN) formed from a composition comprising an amine-aldehyde condensate and a radical inhibitor or quencher.

The durable layer (23), if present, serves as a protective layer to the functional element (24). Suitable raw materials for the durable layer may include, but are not limited to, radiation curable multifunctional acrylates including epoxy acrylates, polyurethane acrylates, polyester acrylates, silicone acrylates, glycidyl acrylates, epoxides, vinyl esters, diallyl phthalate, vinyl ethers and blends thereof. The durable layer may comprise a condensation polymer or copolymer, such as epoxy, polyurethane, polyamide, polyimide, melamine formaldehyde, urea formaldehyde or phenol formaldehyde. The durable layer may comprise a sol-gel silicate or titanium ester.

The durable layer may be partially or fully cured. If partially cured, a post curing step will be employed after the molding and/or transferring step to enhance the durability, particularly hardness, scratch and oil resistance.

To improve the release properties, the raw material, particularly the low molecular weight components of the durable layer is preferably not permeable into the release layer. After the durable layer is coated and cured or partially cured, it should be marginally compatible or incompatible with the release layer. Binders and additives such as thickeners, surfactants, dispersants, UV stabilizers or antioxidants may be used to control the rheology, wettability, coating properties, weatherability and aging properties. Fillers such as silica, Al.sub.2O.sub.3, TiO.sub.2, CaCO.sub.3, microcrystalline wax or polyethylene, Teflon or other lubricating particles may also be added to improve, for example, scratch resistance and hardness of the durable layer. The durable layer is usually about 2 to about 20 microns, preferably about 3 to about 12 microns in thickness. The durable layer, if present, is preferably transparent in a window area.

In addition to the materials described above, other suitable compositions for the optional durable layer are disclosed in US 2005-0181204, US 2005-0171292, and US 2006-0093813, the contents of all of which are incorporated herein by reference in their entirely. For example, US 2005-0181204 discloses a durable layer composition which comprises a thermally crosslinkable and photochemically or radically graftable polymer, a thermal crosslinker and a radiation curable multifunctional monomer or oligomer; US 2005-0171292 discloses a durable layer composition which comprises a polymer or copolymer having at least one carboxylic acid or acid anhydride functionality for thermal crosslinking and at least one UV crosslinkable functionality; and US 2006-0093813 discloses a durable layer composition which comprises an amino crosslinker, a UV curable monomer or oligomer having at least one functional group reactive with the amino crosslinker, an acid catalyst; and a photoinitiator.

The adhesive layer (25) is incorporated into the in-mold transfer films or foils to provide optimum adhesion of the functional element (24) to the surface of the molded object. The adhesive layer may be formed from a material such as polyacrylate, polymethacrylate, polystyrene, polycarbonate, polyurethane, polyester, polyamide, epoxy resin, ethylene vinyl acetate copolymers (EVA), thermoplastic elastomers or the like, or copolymers, blends or composites thereof. Hot melt or heat activated adhesives such as polyurethane and polyamide are particularly preferred. In addition to the materials indicated above, a composition suitable for an adhesive layer is disclosed in US 2006-0019088, the content of which is incorporated herein by reference in its entirety. Briefly, the adhesive layer composition may comprise an adhesive binder and a polymeric particulate material.

The thickness of the adhesive layer may be in the range of about 1 to about 20 microns, preferably in the range of about 2 to about 6 microns.

### (II) In-Mold Insertion Films or Foils

FIG. 2b is a schematic cross-section view of an in-mold insertion film or foil. In this case, the carrier layer (21a) will become part of the finished product after the stamping, lamination or a molding process. The functional element (24) may be applied to the carrier film (21a) with an optional adhesive layer (not shown) and over-coated on the other side of the functional element with a hot melt or heat activated adhesive (25). The adhesive layer applied to the carrier film is not always needed because the functional element may adhere to the carrier film by itself.

The different layers are collectively referred to as the “in-mold insertion film or foil” in this application for ease of illustration.

The in-mold transfer film or foil of Section II above or the in-mold insertion film or foil of Section III may be in the form of a single sheet or in the form of a roll.

### (III) Manufacturing of the Object

A typical in-mold transfer process is illustrated in FIG. 3a. In the molding process, the in-mold transfer film or foil is on a roll or web continuously fed into a molding machine. The mold (30) may be an injection or compression mold for the object (36b). During the molding process, the mold is closed and the plastic melt for the formation of the object is injected into the mold cavity (36a) through injection nozzles and runners. After molding, the functional element and the durable layer, if present, are transferred onto the molded object. The molded object is removed from the mold. The carrier layer (31) and the release layer (32) are simultaneously removed, leaving the durable layer (33), if present, to be the top-most layer on the surface of the object with the functional element (34) embedded underneath as an integral part of the object. The layer (35) is an adhesive layer.

If the durable layer is not present, the functional element will be exposed and it can be connected directly to a power source or other electronic components. If the durable layer is present, there may be holes on the durable layer, through which the functional element may be wired to a power source or other electronic components.

To facilitate the registration of the transfer film or foil to the mold, the roll or web may be pre-printed with registration marks and continuously fed into the mold with registration by, for example, an optical sensor.

In an in-mold insertion process as illustrated in FIG. 3b, an in-mold insertion film or foil is first cut into an appropriate size and shape and then inserted into a mold (30). The in-mold insertion film or foil is placed against the mold wall as shown, optionally under vacuum. The film or foil can be placed manually and an electrostatic charge may be used to facilitate its insertion or the insertion may be mechanized. Mechanized insertion is advantageous especially for large volume production.

The carrier layer (31a) of the insertion film or foil is in contact with the inner wall surface of the mold. The mold is then closed and the plastic melt for the formation of the object (36b) is injected into the mold cavity (36a) through injection nozzles and runners. The carrier layer (31a) in this case may become an integrated part of the finished product. Optionally, the insertion film or foil may be thermoformed to a certain shape and die cut before being inserted into the mold.

Examples of plastic materials suitable for the formation of the object in the stamping, lamination or molding process may include, but are not limited to, thermoplastic materials such as polystyrene, polyvinyl chloride, acrylics, polysulfone, polyarylester, polypropylene oxide, polyolefins, acrylonitrile-butadiene-styrene copolymers (ABS), methacrylate-acrylonitrile-butadiene-styrene copolymers (MABS), polycarbonate, polybutylene terephthalate (PBT), polyethylene terephthalate (PET), polyurethanes and other thermoplastic elastomers or blends thereof, and thermoset materials such as reaction injection molding grade polyurethanes, epoxy resin, unsaturated polyesters, vinyl esters or composites, prepregs and blends thereof.

The mold used for either of the two types of manufacturing process must be designed with the functional element insertion or transfer in mind. Gate locations must allow the functional element to be pressed up against the mold cavity to assure adequate thermal transfer. Also, the mold must be so designed that the functional element after the molding process may be readily connected to a power source. In addition, mold flow and filling analysis should be performed prior to cutting of the mold material. A mold cooling analysis should also be considered to minimize hot spots in the mold. Finally the mold temperature and pressure settings must take into account the presence of the functional element.

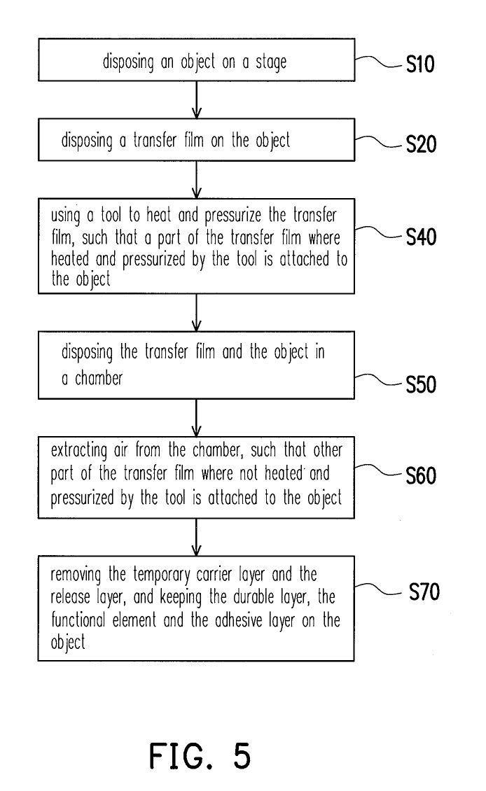

FIG. 4a is a cross-section view of a solid object with a functional element embedded in its surface. The object (40) may have connection cavity in the form of open holes or slots (41) in the body as shown to allow connection of the functional element (42) to a power source. The connection of the functional element to the power source is routed through the holes or slots.

A flex cable (44), or other types of flexible connection harness, can be attached to the functional element by conductive adhesive (45), such as ACF (anisotropic conductive film), conductive PSA (pressure sensitive adhesive) or silver paste, or mechanical clamping.

FIG. 4b illustrates a snap-in plug (46) that can be further inserted to secure the bonding area and enhance the reliability of the connection between the functional element and the power source.

It is also possible to form the object of the present invention by blow molding or thermoforming to create an inner cavity to accommodate the circuitries. For manufacturing an object by blow molding or thermoforming, the transfer or insertion film or foil is first placed into an open mold and held in place by, for example, vacuum or tension; the mold is then closed. The plastic material for forming the object is thermoformed or blown into the mold. The functional element, like in the injection or compression molding process, is embedded in the surface of the molded object.

The surface of the object formed may have the characteristics of anti-glare, anti-reflective or a mat, glossy or rough finish. For example, the surface characteristics may be achieved through the surface design or treatment of the mold itself. Alternatively, they may be achieved through chemical etching or sand blasting performed on the carrier substrate when the release layer is not present which allows the carrier substrate to remain as the top surface of the molded object. During the injection molding process, the surface characteristics are transferred to the molded object.

It is also possible to apply the surface characteristics to the molded object after the injection molding process. For example, a transfer layer having rough and glossy areas may be laminated over the molded object to impart the surface texture onto the surface of the object. In this case, the transfer layer may have rough areas formed by sandpaper, a non-woven fabric or the like or by sand blasting or chemical etching and glossy areas formed by printing a resin layer over them. Alternatively, the rough areas of the transfer layer may be formed by printing an ink over a glossy plastic film. Further alternatively, the surface characteristics of the molded object may be achieved by coating a roughness transfer film over it to create rough areas, followed by partially coating a transparent transfer film over the rough areas to create glossy areas. The roughness transfer film may have a thin metal film layer to provide the desired texture. It is also possible to achieve desired roughness on the surface of a molded object by first partially coating the entire surface with a thin metal film layer, followed by forming a resist layer in areas where the metal film is to remain, etching the surface with an acid or alkali and finally removing the resist layer.

### (IV) Functional Elements

When in use, the object may be held in a way that the functional element is seen or not seen by the user.

As stated above, functional elements suitable for the present invention may include any electrical or mechanical elements which are capable of performing a function.

Electronic designs, such as conductive or semi-conductive electrical traces, may be applied to the release layer, to the durable layer if present, or to the adhesive or tie-coat layer in the in-mold transfer film or foil or to the carrier layer in the in-mold insertion film or foil, by a variety of methods, such as laminating, electroplating, sputtering, vapor deposition, vacuum deposition or a combination thereof.

In one embodiment, the conductive or semi-conductive pattern on a substrate layer involves the use of a photolithographic process. It may also be achieved by direct printing, such as screen, gravure or flexo or lithographic printing.

Alternatively, the formation of conductive or semi-conductive patterns may be achieved by any of the processes as disclosed in US 2003-0203101 and US 2004-0131779, the contents of both publications are incorporated herein by reference in their entirety.

For example, the formation of a conductive or semi-conductive pattern may be carried out by a “positive image printing” process. In this process, a “positive image” is created on the durable layer if present or on the adhesive or tie-coat layer in an in-mold transfer film or foil or on the carrier layer in the in-mold insertion film or foil by printing an area corresponding to a desired pattern with a material that is difficult to strip from the layer. Any ink or printable material that has the characteristic that the subsequently deposited conductive or semi-conductive film adheres to the ink or printed material more strongly than it adheres to the layer, may be used. The printing may be carried out by any printing techniques, such as flexographic, driographic, electro photographic or lithographic printing. Other printing techniques, such as stamping, screen printing, gravure printing, ink jet printing or thermal printing may also be suitable. After formation of the “positive image”, a conductive or semi-conductive material is deposited on the patterned surface of the layer. After deposition of the conductive or semi-conductive material, the conductive or semi-conductive material in the area not covered by the ink or printable material will be removed in a stripping process to reveal the pattern. The stripping may be carried out by using a stripping solvent (which may be an aqueous or organic solvent) capable of removing the conductive or semi-conductive material formed directly on the layer. Alternatively, the stripping may be carried out by mechanical means.

The formation of the conductive or semi-conductive pattern on the durable or adhesive or tie-coat layer in an in-mold transfer film or foil or on the carrier layer in an in-mold insertion film or foil may also be carried out by a “negative image printing” process. In this process, a masking coating or ink is first printed on the layer to create a “negative image” of the desired pattern. In other words, the masking coating or ink is printed in an area where the conductive or semi-conductive material will not be present. In essence, the ink pattern serves as a mask for the subsequent deposition of the conductive or semi-conductive material. Any suitable printing techniques, such as flexographic, driographic, electro photographic or lithographic printing, may be used to print the negative image on the layer. In certain applications, other printing techniques, such as stamping, screen printing, gravure printing, ink jet printing or thermal printing may be suitable, depending on the resolution required. After formation of the “negative image”, a conductive or semi-conductive material is deposited on the patterned surface of the layer. In one embodiment, vapor deposition is used to deposit the conductive or semiconductive material on the patterned side of the layer. In an alternative embodiment, the conductive or semi-conductive material is deposited by sputter coating the patterned side of the layer with the conductive or semi-conductive material. The masking coating or ink is finally stripped from the patterned surface of the layer on which the conductive or semi-conductive material has been deposited. The stripping of the coating/ink has the effect of stripping away the printed negative image formed as well as the portion of the conductive or semi-conductive material that is deposited onto the area of the layer where the coating/ink was present. As a result, the stripping solvent is able to strip away the coating/ink pattern and the conductive or semi-conductive material formed on the top surface of the coating/ink pattern, even though the stripping step is performed after the deposition of the conductive or semi-conductive material.

The conductive or semi-conductive patterns can be used as an interconnector between at least two functional elements or as connecting traces for the same functional element. The conductive or semi-conductive patterns may also perform the function of antennas or electromagnetic shields.

Functional elements themselves can be rigid, although it is preferred to be flexible/deformable.

### (V) Application of Decorative Designs

Text and/or graphic designs may also appear on the surface of the object. The most common designs include brand names, logos or symbols or other decorative designs.

Traditional methods for adding decorative designs include screen printing, pad printing, hot stamping, lamination and painting. These methods historically have been post-molding operations that require additional processing steps.

In recent years, alternative decoration methods, such as the in-mold transfer film or foil or the in-mold insertion film or foil as described above has been used. The decorative design and the functional element may be both present in the film or foil. For example, the decorative designs may be printed on an appropriate layer in the in-mold transfer or insertion film or foil. Suitable materials for the decorative designs may include ink, metal, metal oxide, an inorganic powder or the like. The decoration design may be formed/printed before or after the functional element is added to the film or foil.

The decorative designs may also be formed by thermoforming. In this case, it is usually thermoformed from an ABS, polystyrene or PVC sheet in a mold. Alternatively, the decorative layer may be formed by high pressure forming involving the use of high-pressure air to create decorative designs on a film. The decorative layer may also be formed by hydro forming in which a hydrostatic bladder, rather than air, serves as the forming mechanism.

In one design, the decorative design does not overlap with the functional element on the surface of the object. Alternatively, the decorative design may overlap or partly overlap with the functional element. For example, the functional element may be on top of, or partly on top of, a decorative pattern or the functional element may be underneath, or partly underneath, a decorative pattern. In the latter case, the decorative pattern is visible while the functional element underneath the decorative pattern is connected to wires or connectors. Either one of these options may be used, depending on the application or effect desired.

It is also possible that the decorative pattern and the functional element are on two separate films or foils. The film or foil has the decorative pattern preferably has a durable layer whereas for the film or foil has the functional element, the durable layer is optional. Before the injection process, the decorative film or foil and the functional element film or foil are placed into the mold at different locations.

### (VI) Display Panel

There may also be a display panel appearing on the object. Although this invention covers all display types, it is advantageous to use plastic-based display panels such as polymer dispersed liquid crystal displays (PDLCs), cholesteric liquid crystal displays (ChLCD), organic light emitting devices (OLEDs), electrophoretic displays (EPDs), plastic-based LCD, or other particle based displays.

The display panel may be laminated on top of the surface of the object. Alternatively, the display panel may also be embedded in the surface of the object. The methods for achieving embedding a display panel in the surface of an object is disclosed in US 2005-0163940, the content of which is incorporated herein by reference in its entirety.

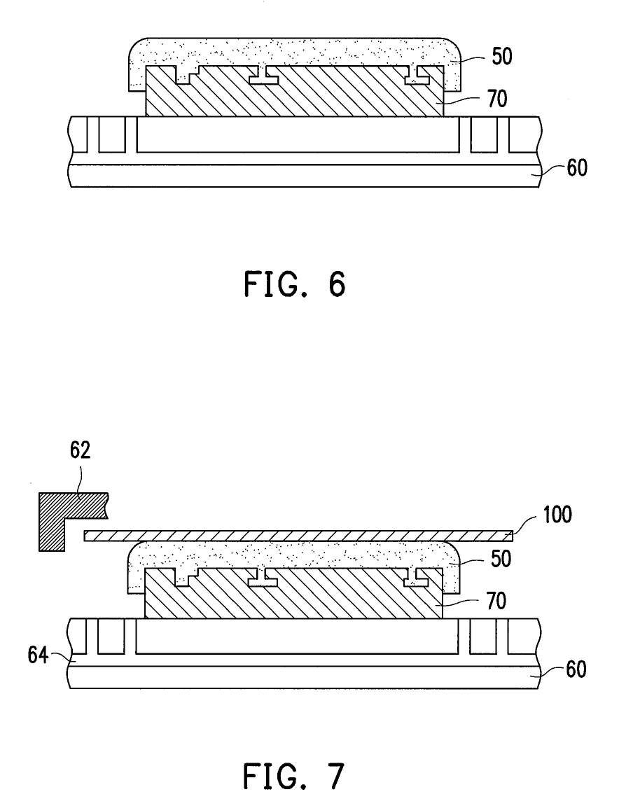

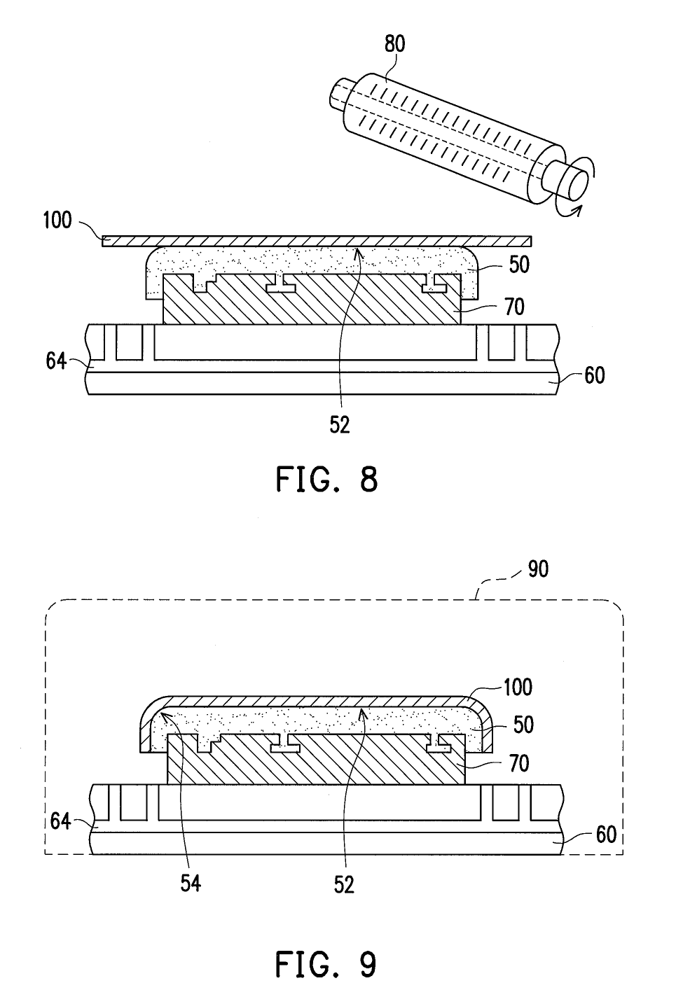

FIG. 5 is a flow chart of a transferring process of an embodiment of the present invention, and FIGS. 6 to 9 illustrate parts of steps of the transferring process in FIG. 5. Please refer to FIGS. 5 and 6, in the transferring process of the present embodiment; an object 50 is disposed on a stage 60 first, step S10. A material of the object 50 may be selected from polycarbonate, polypropylene, polyacrylate, styrene-methyl methacrylate copolymer, acrylonitrile butadiene styrene, polystyrene, polyethylene terephthalate, polyoxymethylene, combination thereof or other material. Furthermore, it is possible that only a material of a part of the object 50 which will be contacted with a transfer film is selected from polycarbonate, polypropylene, polyacrylate, styrene-methyl methacrylate copolymer, acrylonitrile butadiene styrene, polystyrene, polyethylene terephthalate, polyoxymethylene or combination thereof. While the object 50 is molded, it is selectable to dispose the object 50 and part of a mold 70 together on the stage 60.

Please refer to FIGS. 5 and 7; a transfer film 100 is disposed on the object 50, step S20. Selectively, the stage 60 has a fixture 62 for fixing the transfer film 100 on the object 50 after the transfer film 100 is disposed on the object 50.

Please refer to FIGS. 5 and 8, the transfer film 100 is heated and pressurized by using a tool 80, such that a part of the transfer film 100 where heated and pressurized by the tool 80 is attached to the object 50, step S40. The tool 80 of the present embodiment is a roller, and the tool 80 rolls on the transfer film 100 along a fixed direction, and the tool 80 pressurizes and heats the transfer film 100. However, the tool 80 can be not only a roller but also other proper tool. The step of the present embodiment that heating and pressurizing the transfer film 100 by the tool 80 is proceeded at 80° C. to 250° C. Moreover, the part of the transfer film 100 where heated and pressurized by the tool 80 may be attached to a planar surface 52 of the object 50.

Please refer to FIGS. 5 and 9; the transfer film 100 and the object 50 are disposed in a chamber 90, step S50. Then, air is extracted from the chamber 90 to make a vacuum in the chamber 90, such that other part of the transfer film 100 where not heated and pressurized by the tool 80 (shown in FIG. 8) is attached to the object 50, step S60. The transferring process of the present embodiment is substantially finished in here. While extracting air from the chamber 90, a temperature of the chamber 90 can be 50° C. to 300° C. This temperature is lower than a temperature of conventional IMD, and damage of element can be decreased. Moreover, the part of the transfer film 100 where not heated and pressurized by the tool 80 (shown in FIG. 8) can be attached to a non-planar surface 54 of the object 50. An included angle of a junction of the planar surface 52 and the non-planar surface 54 can be 10° to 90°. In other words, the transferring process of the present embodiment can not only transfer the transfer film 100 to the planar surface 52 of the object 50, but also transfer the transfer film 100 to the non-planar surface 54 of the object 50. Meanwhile, the defects such as cracks of the transferred pattern, wrinkle of the transfer film 100 and bubbles between the transfer film 100 and the object 50 can be decreased. Furthermore, the stage 60 may has a vacuum pipeline 64, and air in the chamber 90 is extracted via the vacuum pipeline 64. The stage 60 and the chamber 90 can be belonging to a same apparatus.

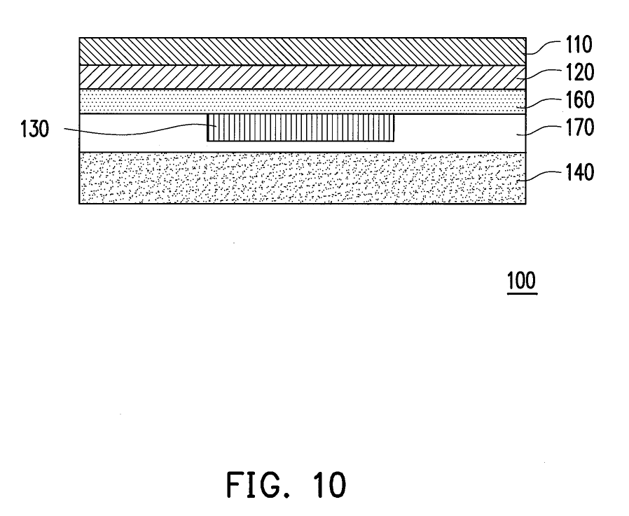

In the transferring process of FIG. 5, the transfer film 100 (shown in FIG. 7) can be the in-mold transfer films or foils of the embodiments of FIG. 2a or 2b. Otherwise, the transfer film 100 may not includes the functional element (24) of FIG. 2a. Else, the transfer film 100 can be the one shown in FIG. 10.

The transfer film 100 of FIG. 10 includes a temporary carrier layer 110, a release layer 120, a functional element 130 and an adhesive layer 140. Selectively, the transfer film 100 may further include a durable layer 160 and an ink layer 170. Materials of the temporary carrier, layer 110, the release layer 120, the functional element 130, the durable layer 160 and the adhesive layer 140 can be the same with the embodiment of FIG. 2a. The functional element 130 can be an integral circuit or other functional element. The release layer 120 is disposed on the temporary carrier layer 110. The durable layer 160 is disposed on the release layer 120, the functional element 130 and the ink layer 170 are disposed on the durable layer 160, and the functional element 130 can be embedded in the ink layer 170. The temporary carrier layer 110 can be outermost while the transfer film 100 is disposed on the object 50 (shown in FIG. 7).

Please refer to FIGS. 5, 9 and 10, the temporary carrier layer 110 and the release layer 120 can be removed, and the durable layer 160, the ink layer 170, the functional element 130 and the adhesive layer 140 can be kept on the object 50 after the other part of the transfer film 100 where not heated and pressurized by the tool 80 is attached to the object 50, step S70.

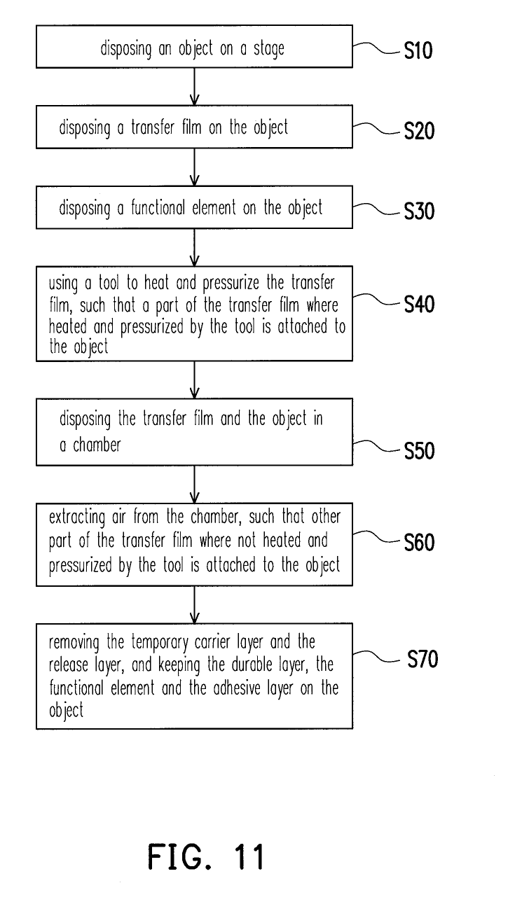

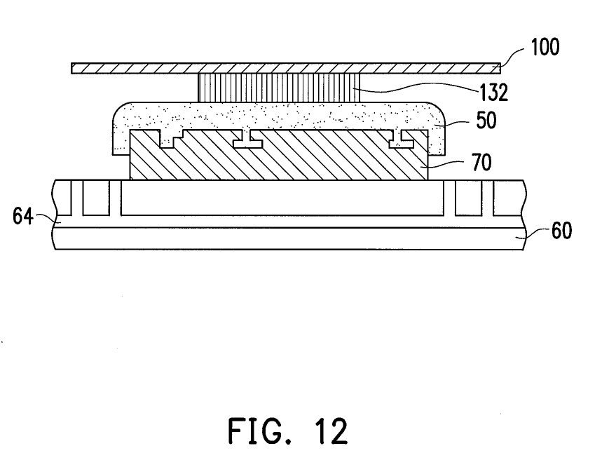

FIG. 11 is a flow chart of a transferring process of another embodiment of the present invention, and FIG. 12 illustrates parts of steps of the transferring process in FIG. 11. Please refer to FIGS. 11 and 12, the transferring process of the present embodiment is similar to the transferring process of FIG. 5, the difference is that a functional element 130 is disposed on the object 50 in the transferring process of the present embodiment before disposing the transfer film 100 on the object 50. The functional element 130 is between the transfer film 100 and the object 50. In other words, the functional element 130 is not embedded in the transfer film 100. The functional element 130 and the transfer film 100 are individual elements.

An object processed by the transferring process of embodiments of the present invention in FIGS. 5 and 11 has better reliability and appearance.

While the present invention has been described with reference to the specific embodiments thereof, it is understood that various changes may be made and equivalents may be substituted without departing from the true spirit and scope of the invention. In addition, many modifications may be made to adapt to a particular situation. All such modifications are intended to be within the scope of the present invention.

What is claimed is:

1. An object having a functional element embedded in its top surface.

2. The object of claim 1 which is formed by molding, stamping, lamination, or a combination thereof.

3. The object of claim 2 wherein said molding process is injection molding, compression molding, thermoforming, or blow molding.

4. The object of claim 1 which is formed from a material selected from the group consisting of thermoplastic materials, thermoplastic elastomers, thermoset materials and blends, prepregs, or composites thereof.

5. The object of claim 1 wherein said functional element is an optical component, optical device, waveguide, electronic design electronic component, display component, backlight component, speaker, microphone, push button, touch panel, touch pad, or connector.

6. The object of claim 5 wherein said electronic design is conductive or semi-conductive electrical traces.

7. The object of claim 5 wherein electronic component is integrated circuit, printed electrical circuit, transistor, diode, resistor, inductor, capacitor, antenna, RFID transponder, battery, solar cell, light-emitting diode, or organic light-emitting diode.

8. The object of claim 1 further comprising a decorative design, a display panel, or both.

9. The object of claim 8 wherein said functional element and said decorative design overlap, partly overlap, or do not overlap.

10. The object of claim 8 wherein said decorative design or display panel is applied post-molding.

11. The object of claim 8 wherein said decorative design or display panel is applied by an in-mold process.

12. An in-mold display transfer film or foil which comprises a temporary carrier film, a release layer, a functional element, an adhesive or tie layer, and optionally a durable layer.

13. The in-mold display transfer film or foil of claim 12 wherein said temporary carrier layer is a thin film of PET, PEN, or PC.

14. The in-mold display transfer film or foil of claim 12 wherein said release layer is formed from wax, paraffin or silicone or a highly smooth and impermeable coating prepared from a radiation curable multifunctional acrylate, silicone acrylate, epoxide, vinyl ester, vinyl ether, allyl or vinyl, unsaturated polyester, or a blend thereof.

15. The in-mold display transfer film or foil of claim 12 wherein said release layer comprises a condensation polymer, copolymer, blend or composite selected from the group consisting of epoxy, polyurethane, polyimide, polyamide, melamine formaldehyde, urea formaldehyde, and phenol formaldehyde.

16. The in-mold display transfer film or foil of claim 12 wherein said optional durable layer is formed from a radiation curable multifunctional acrylate, epoxide, vinyl ester, diallyl phthalate, vinyl ether, or a blend thereof.

17. The in-mold display transfer film or foil of claim 12 wherein said optional durable layer comprises a condensation polymer or copolymer.

18. The in-mold display transfer film or foil of claim 17 wherein said condensation, polymer or copolymer is selected from the group consisting of epoxy, polyurethane, polyamide, polyimide, melamine formaldehyde, urea formaldehyde, and phenol formaldehyde.

19. The in-mold display transfer film or foil of claim 12 wherein said optional durable layer comprises a sol-gel silicate or titanium ester.

20. The in-mold display transfer film or foil of claim 16 wherein said radiation curable multifunctional acrylate is epoxy acrylate, polyurethane acrylate, polyester acrylate, silicone acrylate, or glycidyl acrylate.

21. The in-mold display transfer film or foil of claim 12 wherein said adhesive layer is formed from polyacrylate, polymethacrylate, polystyrene, polycarbonate, polyurethane, polyester, polyamide, epoxy resin, ethylene vinyl acetate copolymer, thermoplastic elastomer, a copolymer thereof, a blend thereof, or a composite thereof.

22. The in-mold display transfer film or foil of claim 12 wherein said adhesive layer is a hot melt or heat activated adhesive.

23. The in-mold display transfer film or foil of claim 12 which is in the form of a roll.

24. An in-mold display insertion film or foil which comprises a carrier layer, a functional element and an adhesive layer.

25. The in-mold display insertion film or foil of claim 24 which is in the form of a roll.

26. A process for the manufacture of an object having a functional element embedded in the top surface of the object, which process comprises:
a) forming an in-mold display transfer film or foil which comprises a temporary carrier layer, a release layer, a functional element, an adhesive layer and optionally a durable layer;
b) feeding said in-mold display transfer film or foil into a mold with the temporary carrier film in contact with the inner surface of the mold;
c) injecting a plastic material into the mold for forming said object or thermoforming, blow molding or compression forming said object with a plastic material in said mold;
d) removing the object formed from the mold; and
e) simultaneously removing both temporary carrier layer and release layer.

27. A process for the manufacture of an object having a functional element embedded in the surface of the object, which process comprises:
a) forming an in-mold display insertion film or foil which comprises a carrier layer, a functional element and an adhesive layer;
b) inserting said in-mold display insertion film or foil into a mold with said carrier layer in contact with the inner surface of the mold;
c) injecting a plastic material into said mold for forming said object or thermoforming, blow molding or compression forming said object with a plastic material in said mold; and
d) removing the formed object from the mold.

28. A transferring process, comprising:
disposing an object on a stage;
disposing a transfer film on the object;
using a tool to heat and pressurize the transfer film, such that a part of the transfer film where heated and pressurized by the tool is attached to the object;
disposing the transfer film and the object in a chamber; and
extracting air from the chamber, such that other part of the transfer film where not heated and pressurized by the tool is attached to the object.

29. The transferring process of claim 28, wherein the transfer film comprises:
a temporary carrier layer;
a release layer, disposed on the temporary carrier layer;
a functional element, disposed on the release layer; and
an adhesive layer, disposed on the release layer, wherein while the transfer film is disposed on the object, the functional element and the adhesive layer are between the object and the temporary carrier layer.

30. The transferring process of claim 29, wherein the transfer film further comprise a durable layer, the durable layer disposed on the release layer, and the functional element and the adhesive layer is disposed on the durable layer.

31. The transferring process of claim 30, further comprising removing the temporary carrier layer and the release layer, and keeping the durable layer, the functional element and the adhesive layer on the object after the other part of the transfer film where not heated and pressurized by the tool is attached to the object.

32. The transferring process of claim 29, wherein the transfer film further comprise an ink layer, the ink layer is disposed on the release layer and covers the functional element, and the adhesive layer is disposed on the ink layer.

33. The transferring process of claims 29, wherein the functional element is an integral circuit.

34. The transferring process of claim 28, further comprising disposing a functional element on the object before disposing the transfer film on the object, wherein the functional element is between the transfer film and the object.

35. The transferring process of claims 34, wherein the functional element is an integral circuit.

36. The transferring process of claim 28, wherein the step of using the tool to heat and pressurize the transfer film is using a roller to heat and pressurize the transfer film.

37. The transferring process of claim 28, wherein the step of using the tool to heat and pressurize the transfer film is proceeded at 80° C. to 250° C.

38. The transferring process of claim 28, wherein a temperature of the chamber during extracting air from the chamber is 50° C. to 300° C.

39. The transferring process of claim 28, wherein the stage has a fixture for fixing the transfer film on the object after disposing the transfer film on the object.

40. The transferring process of claim 28, wherein the part of the transfer film where heated and pressurized by the tool is attached to a planar surface of the object, and the other part of the transfer film where not heated and pressurized by the tool is attached to an non-planar surface of the object, an included angle of a junction of the non-planar surface and the planar surface is 10° to 90°.

41. The transferring process of claim 28, wherein the stage has a vacuum pipeline, the step that extracting air from the chamber is proceeded via the vacuum pipeline.

42. An object processed with the transferring process of any of claims 28.

43. The object of claim 42, wherein a material of a part of the object contacted with the transfer film is selected from polycarbonate, polypropylene, polyacrylate, styrene-methyl methacrylate copolymer, acrylonitrile butadiene styrene, polystyrene, polyethylene terephthalate, polyoxymethylene or combination thereof.
